(19) United States
(12) Patent Application Publication
(10) Pub. No.: US 2026/0173115 A1
(43) Pub. Date: Jun. 18, 2026

(54) SYSTEM INFORMATION FOR VIRTUAL CELLS IN WIRELESS COMMUNICATIONS SYSTEMS

(71) Applicant: QUALCOMM Incorporated, San Diego, CA (US)

(72) Inventors: Aria HASANZADEZONUZY, Chatham, NJ (US); Kianoush HOSSEINI, San Diego, CA (US)

(21) Appl. No.: 18/981,344

(22) Filed: Dec. 13, 2024

(51) Int. Cl. H04W 72/27; H04W 74/0833

(52) U.S. Cl. CPC H04W 72/27; H04W 74/0833

(57) ABSTRACT

Methods, systems, and devices for wireless communications are described. A user equipment (UE) may communication with a virtual cell (vCell), which may include a set of serving cells that are grouped together to facilitate wireless communication. To implement communications with such vCells, the UE may receive control signaling that indicates one or more resources for reception of system information (SI) that is associated with the vCell. According to the control signaling, the UE may receive the SI via the one or more resources. The SI may include a first information element (IE) associated with a first parameter that is specific to at least one serving cell of the set of serving cells of the vCell, and a second IE associated with a second parameter that is common across two or more serving cells of the set of serving cells of the vCell.

### FIELD OF TECHNOLOGY

The following relates to wireless communications, including system information (SI) for virtual cells (vCells) in wireless communications systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling that indicates one or more resources for reception of system information (SI) associated with a virtual cell (vCell), where the vCell includes a set of serving cells that are grouped together to facilitate wireless communication, receiving the SI via the one or more resources, where the SI includes a first IE (IE) associated with a first parameter that is specific to at least one serving cell of the set of serving cells, and a second IE associated with a second parameter that is common across two or more serving cells of the set of serving cells, and communicating via the set of serving cells of the vCell in accordance with the SI.

A UE for wireless communications is described. The UE may include one or more memories storing processor executable code, and one or more processors coupled with the one or more memories. The one or more processors may individually or collectively be operable to execute the code to cause the UE to receive control signaling that indicates one or more resources for reception of SI associated with a vCell, where the vCell includes a set of serving cells that are grouped together to facilitate wireless communication, receive the SI via the one or more resources, where the SI includes a first IE associated with a first parameter that is specific to at least one serving cell of the set of serving cells, and a second IE associated with a second parameter that is common across two or more serving cells of the set of serving cells, and communicate via the set of serving cells of the vCell in accordance with the SI.

Another UE for wireless communications is described. The UE may include means for receiving control signaling that indicates one or more resources for reception of SI associated with a vCell, where the vCell includes a set of serving cells that are grouped together to facilitate wireless communication, means for receiving the SI via the one or more resources, where the SI includes a first IE associated with a first parameter that is specific to at least one serving cell of the set of serving cells, and a second IE associated with a second parameter that is common across two or more serving cells of the set of serving cells, and means for communicating via the set of serving cells of the vCell in accordance with the SI.

A non-transitory computer-readable medium storing code for wireless communications is described. The code may include instructions executable by one or more processors to receive control signaling that indicates one or more resources for reception of SI associated with a vCell, where the vCell includes a set of serving cells that are grouped together to facilitate wireless communication, receive the SI via the one or more resources, where the SI includes a first IE associated with a first parameter that is specific to at least one serving cell of the set of serving cells, and a second IE associated with a second parameter that is common across two or more serving cells of the set of serving cells, and communicate via the set of serving cells of the vCell in accordance with the SI.

In some examples of the method, UEs, and non-transitory computer-readable medium described herein, the first IE includes a list of entries and each entry of the list of entries includes a mapping between the first parameter and an identifier (ID) of a respective serving cell of the set of serving cells.

In some examples of the method, UEs, and non-transitory computer-readable medium described herein, the ID of the respective serving cell includes a physical cell ID (PCID), an absolute radio frequency channel number (ARFCN), a subband ID, a component carrier (CC) ID, or a cell ID.

In some examples of the method, UEs, and non-transitory computer-readable medium described herein, a first entry in the list of entries includes a mapping between the first parameter and respective IDs of multiple serving cells of the set of serving cells and the first parameter may be common across the multiple serving cells.

Some examples of the method, UEs, and non-transitory computer-readable medium described herein may further include operations, features, means, or instructions for receiving, from a first serving cell of the set of serving cells, second SI usable for communications with the first serving cell individually and separately from the vCell.

In some examples of the method, UEs, and non-transitory computer-readable medium described herein, the SI includes a flag that indicates that the first parameter for the first serving cell may be equivalent to a third parameter of the second SI.

In some examples of the method, UEs, and non-transitory computer-readable medium described herein, the second IE includes a mapping between the second parameter and respective IDs for the two or more serving cells of the set of serving cells.

In some examples of the method, UEs, and non-transitory computer-readable medium described herein, the SI may include operations, features, means, or instructions for a third IE associated with a third parameter for a first step of a random-access procedure between the UE and the vCell, a fourth IE associated with a fourth parameter for a second step of the random-access procedure, a fifth IE associated with a fifth parameter for a third step of the random-access procedure, and a sixth IE associated with a sixth parameter for a fourth step of the random-access procedure.

In some examples of the method, UEs, and non-transitory computer-readable medium described herein, the third IE further includes a mapping between the third parameter and one or more first serving cells of the set of serving cells, the fourth IE further includes a mapping between the fourth parameter and one or more second serving cells of the set of serving cells, the fifth IE includes a mapping between the fifth parameter and one or more third serving cells of the set of serving cells, and the sixth IE includes a mapping between the sixth parameter and one or more fourth serving cells of the set of serving cells.

A method for wireless communications by a network entity is described. The method may include transmitting control signaling that indicates one or more resources for reception of SI associated with a vCell, where the vCell includes a set of serving cells that are grouped together to facilitate wireless communications between the network entity and a UE, transmitting the SI via the one or more resources, where the SI includes a first IE associated with a first parameter that is specific to at least one serving cell of the set of serving cells and a second IE associated with a second parameter that is common across two or more serving cells of the set of serving cells of the vCell, and communicating via the set of serving cells of the vCell in accordance with the SI.

A network entity for wireless communications is described. The network entity may include one or more memories storing processor executable code, and one or more processors coupled with the one or more memories. The one or more processors may individually or collectively be operable to execute the code to cause the network entity to transmit control signaling that indicates one or more resources for reception of SI associated with a vCell, where the vCell includes a set of serving cells that are grouped together to facilitate wireless communications between the network entity and a UE, transmit the SI via the one or more resources, where the SI includes a first IE associated with a first parameter that is specific to at least one serving cell of the set of serving cells and a second IE associated with a second parameter that is common across two or more serving cells of the set of serving cells of the vCell, and communicate via the set of serving cells of the vCell in accordance with the SI.

Another network entity for wireless communications is described. The network entity may include means for transmitting control signaling that indicates one or more resources for reception of SI associated with a vCell, where the vCell includes a set of serving cells that are grouped together to facilitate wireless communications between the network entity and a UE, means for transmitting the SI via the one or more resources, where the SI includes a first IE associated with a first parameter that is specific to at least one serving cell of the set of serving cells and a second IE associated with a second parameter that is common across two or more serving cells of the set of serving cells of the vCell, and means for communicating via the set of serving cells of the vCell in accordance with the SI.

A non-transitory computer-readable medium storing code for wireless communications is described. The code may include instructions executable by one or more processors to transmit control signaling that indicates one or more resources for reception of SI associated with a vCell, where the vCell includes a set of serving cells that are grouped together to facilitate wireless communications between the network entity and a UE, transmit the SI via the one or more resources, where the SI includes a first IE associated with a first parameter that is specific to at least one serving cell of the set of serving cells and a second IE associated with a second parameter that is common across two or more serving cells of the set of serving cells of the vCell, and communicate via the set of serving cells of the vCell in accordance with the SI.

In some examples of the method, network entities, and non-transitory computer-readable medium described herein, the first IE includes a list of entries and each entry of the list of entries includes a mapping between the first parameter and an ID of a respective serving cell of the set of serving cells.

In some examples of the method, network entities, and non-transitory computer-readable medium described herein, the ID of the respective serving cell includes a PCID, an ARFCN, a subband ID, a CC ID, or a cell ID.

In some examples of the method, network entities, and non-transitory computer-readable medium described herein, a first entry in the list of entries includes a mapping between the first parameter and respective IDs of multiple serving cells of the set of serving cells and the first parameter may be common across the multiple serving cells.

Some examples of the method, network entities, and non-transitory computer-readable medium described herein may further include operations, features, means, or instructions for transmitting, via a first serving cell of the set of serving cells, second SI usable for communicating with the first serving cell individually and separately from the vCell.

In some examples of the method, network entities, and non-transitory computer-readable medium described herein, the SI includes a flag that indicates that the first parameter for the first serving cell may be equivalent to a third parameter of the second SI.

In some examples of the method, network entities, and non-transitory computer-readable medium described herein, the second IE includes a mapping between the second parameter and respective IDs for the two or more serving cells of the set of serving cells.

In some examples of the method, network entities, and non-transitory computer-readable medium described herein, the SI may include operations, features, means, or instructions for a third IE associated with a third parameter for a first step of a random-access procedure between the UE and the vCell, a fourth IE associated with a fourth parameter for a second step of the random-access procedure, a fifth IE associated with a fifth parameter for a third step of the random-access procedure, and a sixth IE associated with a sixth parameter for a fourth step of the random-access procedure.

In some examples of the method, network entities, and non-transitory computer-readable medium described herein, the third IE further includes a mapping between the third parameter and one or more first serving cells of the set of serving cells, the fourth IE further includes a mapping between the fourth parameter and one or more second serving cells of the set of serving cells, the fifth IE includes a mapping between the fifth parameter and one or more third serving cells of the set of serving cells, and the sixth IE includes a mapping between the sixth parameter and one or more fourth serving cells of the set of serving cells.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports system information (SI) for virtual cells (vCells) in wireless communications systems in accordance with one or more aspects of the present disclosure.

FIG. 2 shows an example of a wireless communications system that supports SI for vCells in wireless communications systems in accordance with one or more aspects of the present disclosure.

FIG. 3 shows an example of a resource diagram that supports SI for vCells in wireless communications systems in accordance with one or more aspects of the present disclosure.

FIG. 4 shows an example of a process flow that supports SI for vCells in wireless communications systems in accordance with one or more aspects of the present disclosure.

FIGS. 5 and 6 show block diagrams of devices that support SI for vCells in wireless communications systems in accordance with one or more aspects of the present disclosure.

FIG. 7 shows a block diagram of a communications manager that supports SI for vCells in wireless communications systems in accordance with one or more aspects of the present disclosure.

FIG. 8 shows a diagram of a system including a device that supports SI for vCells in wireless communications systems in accordance with one or more aspects of the present disclosure.

FIGS. 9 and 10 show block diagrams of devices that support SI for vCells in wireless communications systems in accordance with one or more aspects of the present disclosure.

FIG. 11 shows a block diagram of a communications manager that supports SI for vCells in wireless communications systems in accordance with one or more aspects of the present disclosure.

FIG. 12 shows a diagram of a system including a device that supports SI for vCells in wireless communications systems in accordance with one or more aspects of the present disclosure.

FIGS. 13 through 16 show flowcharts illustrating methods that support SI for vCells in wireless communications systems in accordance with one or more aspects of the present disclosure.

### DETAILED DESCRIPTION

In order to facilitate wireless communications within a wireless communications system, a user equipment (UE) may connect with a serving cell supported by one or more network entities (e.g., base stations). Some wireless networks, such as Fifth Generation (5G) networks, support carrier aggregation or multi-cell operation in which the UE first attaches to and communicates with a primary cell (PCell) (e.g., first component carrier (CC)), then may subsequently connect to other secondary cells (SCells) (e.g., additional CCs). That is, in some wireless networks, separate serving cells operate separately from one another, and may be accessed using separate random access channel (RACH) procedures or other attachment procedures to communicate with the respective cells. Further, in such wireless networks, the parameters for communicating with the PCell and the SCell may be separately configured or established. Such carrier aggregation/multi-cell configurations enable the UE to communicate via multiple cells, which may increase overall throughput and reliability of wireless communications. However, the UE may have relatively little control over which cells/CCs are configured at the UE. Further, performing multiple RACH procedures to attach to multiple cells/CCs may increase the latency with which the UE is able to connect and communicate with the respective cells.

Comparatively, some other wireless networks, such as Sixth Generation (6G) networks, may operate according to service-based access techniques, where resources are allocated based on different application/service needs for the UE. For example, in the context of a 6G network, a UE may attach, connect, or “subscribe” to a set of cells for different applications or services, such as authentication services, gaming services, and the like. In order to support such service-based access, such wireless networks may implement the concept of a “virtual cell” (vCell), which may include (e.g., be composed of) multiple serving cells, multiple sub-bands, multiple CCs, multiple portions of a sub-band, and the like. In such cases, the respective serving cells of a vCell may be grouped together to facilitate wireless communications for one or more applications/services (e.g., an “authentication” vCell that includes multiple serving cells that are grouped together to facilitate wireless communications for authentication services). By connecting with a vCell, the UE may communicate with multiple serving cells, thereby increasing bandwidth and reducing latency, among other advantages. As compared to previous carrier aggregation/multi-cell operation, in which the UE is required to perform separate RACH procedures to attach to PCells and SCells, the UE may be able to perform a single RACH procedure with the vCell to connect to and communicate with all the respective serving cells of the vCell.

For the purposes of the present disclosure, and in the context of a “vCell,” the terms “cell,” “serving cell,” “CC,” “sub-band,” and like terms, may be used interchangeably to refer to subsets of time/frequency resources of a vCell that may be aggregated, combined, bundled, or otherwise grouped together to form the vCell and to facilitate wireless communications via the vCell.

As will be described in further detail herein, the respective serving cells of a vCell may be supported by one or more network entities. That is, the respective serving cells of a vCell may be co-located (e.g., supported by a single network entity), or non-co-located (e.g., supported by multiple, separate network entities). In some aspects, communications parameters for accessing/communicating with a given serving cell 205 individually may be the same or different compared to communications parameters for accessing/communicating with the same serving cell 205 as part of a vCell 210.

In the context of both conventional carrier aggregation and vCell operation, the UE may receive system information (SI) that indicates one or more parameters used by the UE to communicate with a serving cell. In the context of previous carrier-aggregation/multi-cell operation, such SI may be separately signaled and configured for separate serving cells. However, current signaling techniques used to indicate SI may not support indication of SI for vCells. For example, in the context of a vCell, some wireless communications parameters may be shared across all (or a subset) of the serving cells of the vCell, where other wireless communications parameters may be unique for each respective serving cell of the vCell. In such cases, conventional SI signaling techniques may be unable to convey all the requisite SI for the multiple serving cells of the vCell concurrently serving the UE.

The techniques, methods, and devices described herein provide for communication of SI message(s) for a vCell, which may enable the UE to access and communicate with a vCell. For example, the UE may receive, from one or more serving cells of the vCell, the SI. In such examples, the SI may include a first IE associated with a first parameter specific to each serving cell of the set of serving cells. That is, the first IE may include a list of entries, where each entry provides a mapping between the first parameter and a respective serving cell of the vCell. The SI may further include a second IE associated with a second parameter that is common across multiple (e.g., two or more) serving cells of the vCell. Stated differently, the SI may include IEs that are common across all (or a subset) of the serving cells of the vCell, and IEs that are specific or unique to respective serving cells of the vCell. The UE may communicate with the set of serving cells of the vCell according to the SI. By implementing such SI, the UE may communicate via the vCell (e.g., via the set of serving cells), thereby increasing bandwidth, reducing latency, and improving coordination between the vCell and the UE, among other advantages.

Aspects of the disclosure are initially described in the context of wireless communications systems. Aspects of the disclosure are further described in the context of resource diagrams and process flows. Aspects of the disclosure are further illustrated by and described with reference to apparatus diagrams, system diagrams, and flowcharts that relate to SI for vCells in wireless communications systems.

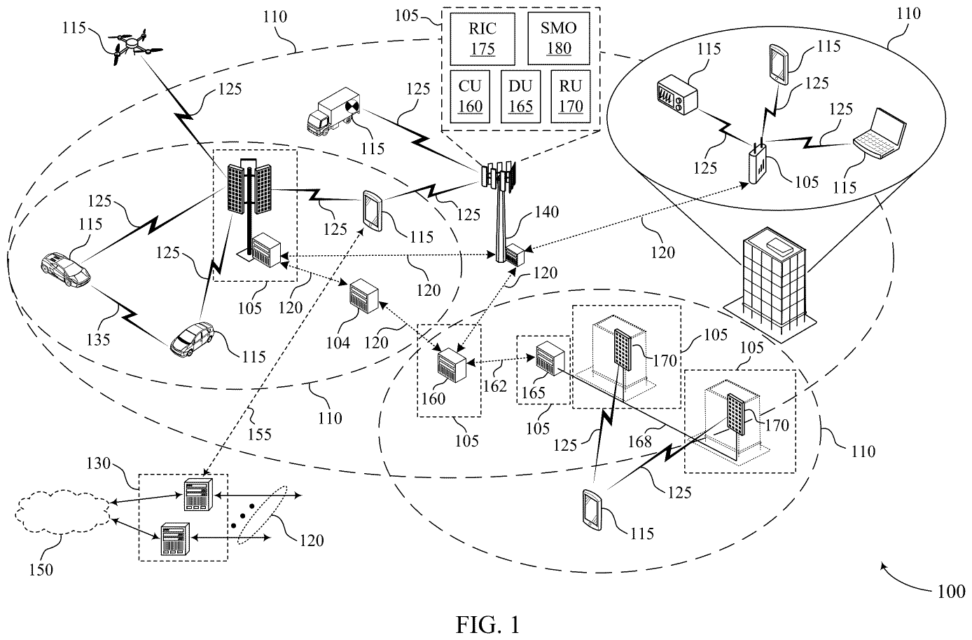

FIG. 1 shows an example of a wireless communications system 100 that supports SI for vCells in wireless communications systems in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support SI for vCells in wireless communications systems as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, SI), control signaling that coordinates operation for the carrier, user data, or other signaling. The wireless communications system 100 may support communication with a UE 115 using carrier aggregation or multi-carrier operation. A UE 115 may be configured with multiple downlink CCs and one or more uplink CCs according to a carrier aggregation configuration. Carrier aggregation may be used with both frequency division duplexing (FDD) and time division duplexing (TDD) CCs. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with CCs operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UE 115 may connect with a serving cell in the wireless communications system 100. To facilitate communications between the UE 115 and the serving cell, the serving cell may transmit SI to the UE 115, where the SI may indicate one or more parameters used by the UE 115 to communicate with the serving cell. In some cases, the wireless communications system 100 may implement a vCell, which may include (e.g., be composed of) multiple serving cells (e.g., multiple sub-bands, multiple CCs, multiple portions of a sub-band, among other examples). By implementing the vCell, the UE 115 may communicate with multiple serving cells, thereby increasing bandwidth and reducing latency, among other advantages. In such cases, however, current signaling techniques may not support indication of system information for vCells, for example, because current signaling techniques may not support indication of SI message for multiple serving cells concurrently serving the UE 115.

The techniques, methods, and devices described herein provide for communication of SI message(S) for a vCell, which may enable the UE 115 to access and communicate with a vCell. For example, the UE 115 may receive, from one or more serving cells of the vCell, the SI. In such examples, the SI may include a first IE associated with a first parameter specific to each serving cell of the set of serving cells. That is, the first IE may include a list of entries, where each entry provides a mapping between the first parameter and a respective serving cell. The SI may further include a second IE associated with a second parameter that is common across multiple (e.g., two or more) serving cells of the set of serving cells. Stated differently, the SI may include IEs that are common across all (or a subset) of the serving cells of the vCell, and IEs that are specific or unique to respective serving cells of the vCell. The UE 115 may communicate with the set of serving cells of the vCell according to the SI. By implementing such SI, the UE 115 may communicate via the vCell (e.g., via the set of serving cells), thereby increasing bandwidth, reduce latency, and improve coordination between the vCell and the UE 115, among other advantages.

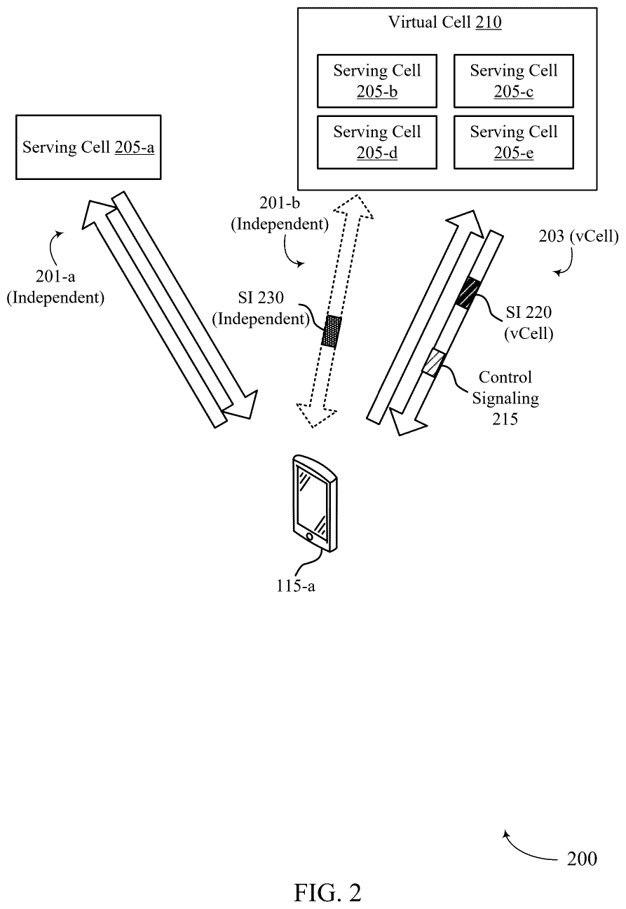

FIG. 2 shows an example of a wireless communications system 200 that supports SI for vCells in wireless communications systems in accordance with one or more aspects of the present disclosure. The wireless communications system 200 may implement, or be implemented by, aspects of the wireless communications system 100. For example, the wireless communications system 200 may include a UE 115-a, which may be an example of a UE 115, as described herein with reference to FIG. 1. The techniques described in the context of the wireless communications system 200 may enable the UE 115-a to receive SI 220 for a vCell 210.

In order to perform wireless communications, the UE 115-a may communicate with a serving cell 205, such as the serving cell 205-a. A serving cell 205 may provide the primary network coverage and connectivity to the UE 115-a via a main (e.g., primary) communication link 201-a between the UE 115-a and the wireless network (e.g., the 5G NR network). As described herein, a serving cell 205 may be referred to as a sub-band, a CC (e.g., a sub-band or a portion of a sub-band), or a frequency resource. In this regard, the terms “cell,” “serving cell,” “CC,” “sub-band,” and like terms, may be used interchangeably to refer to subsets of time/frequency resources.

In some wireless communications networks, such as 5G networks, the UE 115-a may select the serving cell 205-a (e.g., a PCell) from multiple serving cells 205 according to a reference signal received power (RSRP) of each serving cell 205, among other examples. Based on selecting the serving cell 205-a, the UE 115-a may enter a connected mode (e.g., RRC connected mode). While operating in the connected mode, if the UE 115-a supports carrier aggregation (e.g., either in the uplink or downlink), a network entity 105 may configure one or more SCells in addition to the serving cell 205-a (e.g., PCell) for communication with the UE 115-a. Accordingly, if the UE 115-a is scheduled to communicate data, the network entity 105 may activate and schedule the SCells for communications with the UE 115-a.

As an illustrative example, the UE 115-a may support downlink carrier aggregation, where the UE 115-a may receive data from the serving cell 205-a and one or more SCells simultaneously. Similarly, the UE 115-a may support uplink carrier aggregation, where the UE 115-a may transmit data to the wireless network via the serving cell 205-a and one or more SCells simultaneously.

In some cases, however, the network entity 105 may configure (e.g., allocate or assign) the one or more SCells blindly. For example, the network entity 105 may configure the SCells independent of the traffic patterns at the UE 115-a, independent of the applications associated with the UE 115-a, or independent of the coverage condition of the UE 115-a (e.g., whether the UE 115-a is located at the cell-edge or cell-center), among other examples.

As such, except for reporting capabilities associated with carrier aggregations, the UE 115-a may not have control of which SCells (e.g., CCs) are configured for carrier aggregation (e.g., in both uplink and downlink), where such configured SCells may not adequately support the applications associated with the UE 115-a and may have a negative impact on the power consumption of the UE 115-a.

In some cases, it may be desirable to configure the downlink and uplink SCells (e.g., frequency resources, CCs) according to the traffic patterns of the applications associated with the UE 115-a. For example, the UE 115-a may be enabled to access one or more SCells (e.g., the carrier aggregation combination) that are based on the service metrics at the UE 115-a, based on the coverage conditions at the UE 115-a, and based on the capabilities of the UE 115-a.

That is, the UE 115-a may be enabled to perform vCell 210 selection and re-selection with downlink and uplink serving cells 205 according to various conditions at the UE 115-a. By doing so, the UE 115-a may experience an improvement in capacity (e.g., bandwidth) for downlink communications, while also experiencing an improvement in capacity as well as coverage for uplink communications. For downlink communications, improving capacity may be a primary target or goal, while for uplink communications, depending on the UE 115 coverage situation in the cell, capacity as well as coverage may considered the main key performance indicators (KPIs).

As described herein, a vCell 210 may include (e.g., be composed of) one or more serving cells 205 (e.g., multiple sub-bands, CCs, frequency resources), where each serving cell 205 of a vCell 210 may be allocated as either an uplink serving cell 205, a downlink serving cell 205, or both an uplink and downlink serving cell 205. As an illustrative example, the vCell 210 may include four serving cells 205, such as the serving cell 205-b, the serving cell 205-c, the serving cell 205-d, and the serving cell 205-e. The respective serving cells 205 of the vCell 210 may be grouped together to facilitate wireless communications for one or more applications/services. For instance, the vCell 210 may support authentication services, where the respective serving cells 205 of the vCell 210 may be combined, bundled, or otherwise grouped together to support various aspects of the authentication services.

As described previously herein, in some wireless networks, such as 5G networks, the UE 115-a may first attach to and communicate with a PCell (e.g., serving cell 205-a), then may subsequently connect to other SCells. That is, in some wireless networks, separate serving cells 205 may operate separately from one another, and must be accessed using separate RACH procedures or other attachment procedures to communicate with the respective cells. Further, in such wireless networks, the parameters for communicating with the individual serving cells 205-a may be separately configured or established.

Comparatively, some other wireless networks, such as 6G networks, may implement the concept of a vCell 210, which may include (e.g., be composed of) multiple serving cells 205, multiple sub-bands, multiple CCs, multiple portions of a sub-band, and the like. In such cases, the respective serving cells 205 of the vCell 210 may be grouped together to facilitate wireless communications for one or more applications/services. As compared to previous carrier aggregation/multi-cell operation, in which the UE 115-a is required to perform separate RACH procedures to attach to PCells and SCells, the UE 115-a may be able to perform a single RACH procedure with the vCell 210 to connect to and communicate with all the respective serving cells 205 of the vCell 210.

In this regard, the serving cell 205-a may be an example of a “standalone” serving cell 205-a that may or may not be a part of a vCell 210, and which is accessible via a communication link 201-a. Comparatively, the vCell 210 may include a group of serving cells 205-b, 205-c, 205-d, 205-e that are aggregated, bundled, or otherwise grouped together to facilitate wireless communications via one or more communication links, such as the communication link 203.

Furthermore, in addition to facilitating communications as part of the vCell 210, the respective serving cells 205 of the vCell 210 may also support or otherwise facilitate wireless communications with the UE 115 that are separate or independent from the vCell 210 (e.g., via a communication link 201-b for “independent” communications). That is, each of the respective serving cells 205 may be accessible individually (e.g., as standalone serving cells 205, such as in 5G), and/or as part of a vCell 210 (e.g., as a group of serving cells 205, such as in 6G). For example, the UE 115-a may communicate with the serving cell 205-d as part of the vCell 210 via the communication link 203, and may additionally and/or alternatively communicate with the same serving cell 205-d separately/independently from the vCell 210 via the communication link 201-b.

In some examples, each of the serving cells 205 of the vCell 210 may be operated by a single network entity 105 (e.g., co-located). In other examples, a first subset of the serving cells 205 of the vCell 210 may be operated by a first network entity 105 and a second subset of the serving cells 205 of the vCell 210 may be operated by a second network entity 105 (e.g., non-co-located).

In such cases, one or more vCells 210 may be formed (e.g., allocated) each having a different combination of serving cells 205. In some examples, the network entity 105 may form the vCell 210, where, to form the vCell 210, the network entity 105 may select the serving cells 205 and indicate the vCell 210 to the UE 115-a. Alternatively, the network entity 105 may indicate “candidate” serving cells 205 which may be bundled/grouped to form a vCell 210, where the UE 115-a may form the vCell 210 by selecting a set of serving cells 205 from the set of candidate serving cells 205. Accordingly, a complete vCell 210, one either formed by the UE 115-a or the network entity 105, may include serving cells 205 that enable the UE 115-a to access the vCell 210 (e.g., include uplink and downlink serving cells 205). As such, if each step of a RACH procedure could be performed using the serving cells 205 of a vCell 210, then the vCell 210 is complete.

As part of UE-initiated access (e.g., in uplink), the UE 115-a may be aware of the current service metrics and coverage conditions, such that the UE 115-a may select one of the formed vCells 210 accordingly (e.g., select a carrier aggregation combination). Additionally, for downlink, the UE 115-a may utilize a paging procedure to identify and select one of the formed vCells 210.

Accordingly, such service-based access may provide a universal access solution for different tiers of UEs 115. For example, a first tier of UEs 115 may aggregate an increased quantity of serving cells 205 within a vCell 210 (e.g., an increased quantity of bandwidth), while a second tier of UEs 115 may select a single serving cell 205 (e.g., a limited BW) for communications. As such, if a network entity 105 advertises different vCells 210, each including a different quantity of downlink and uplink serving cells 205, each UE 115 can select a vCell 210 according to the service metrics, traffic patterns, coverage conditions, and capabilities, among other examples.

In some aspects, the use of vCells 210 may reduce the latency with which the UE 115-a is able to connect and communicate with the respective serving cells 205 of the vCell 210. That is, the configuration of the SCells in conventional carrier aggregation contexts may increase latency. In particular, in the context of conventional carrier aggregation/multi-cell operation, downlink and uplink SCell configurations may account for a relatively large portion of latency to get the SCells to an operational state. As an illustrative example, the latency associated with downlink SCell configuration latency may account for approximately 43% of the total latency, while the latency for uplink SCell configuration may account for approximately about 83% of the total latency.

For instance, to configure the SCells in conventional downlink carrier aggregation, the UE 115-a may transmit a first RRC message (e.g., RRC Setup Comp) to request the configuration of one or more SCells. In response, the network entity 105 may transmit a second RRC message (e.g., RRC Reconfig) including the carrier aggregation configuration that configures one or more SCells, where the UE 115-a may transmit a third RRC message (e.g., RRC Reconfig Complete) indicating that the UE 115-a has received the carrier aggregation configuration.

In response to receiving the third RRC message, the network entity 105 may transmit a MAC control element (MAC-CE) activating a first SCell of the one or more SCells indicated in the carrier aggregation configuration. Accordingly, the UE 115-a may perform channel measurements on the first SCell and transmit channel state feedback (e.g., channel state information (CSI)) to the network entity 105. If the channel state feedback of the first SCell is sufficient, the network entity 105 may schedule a data (e.g., a physical downlink shared channel (PDSCH) transmission) via the first SCell, such that the UE 115-a may receive the data via the first SCell.

In such cases, however, the UE 115-a may experience an increased configuration delay between the transmission of the first RRC message and the reception of the second RRC message, experience an activation delay between transmission of the third RRC message and reception of the MAC-CE, and experience a scheduling delay between the transmission of the channel state feedback and the reception of the data.

Similarly, to configure the SCells in conventional uplink carrier aggregation, the UE 115-a may transmit a first RRC message (e.g., RRC Setup Comp) to request the configuration of one or more SCells. In response, the network entity 105 may transmit a second RRC message (e.g., RRC Reconfig, event A1) and transmit a third RRC message (e.g., RRC Reconfig) that includes the carrier aggregation configuration that configures one or more SCells.

In response to receiving the carrier aggregation configuration, the UE 115-a may transmit a buffer status report (BSR) indicating a quantity of data to be transmitted from the UE 115-a. Based on receiving the BSR, the network entity 105 may transmit a MAC-CE activating a first SCell of the one or more SCells indicated in the carrier aggregation configuration. The network entity 105 may also transmit resources via which the UE 115-a may transmit the data (e.g., physical uplink shared channel (PUSCH)).

In such cases, however, the UE 115-a may experience an increased configuration delay between the transmission of the first RRC message and the reception of the second and third RRC messages, experience an activation delay between reception of the third RRC message and reception of the MAC-CE, and experience a scheduling delay between reception of MAC-CE and the reception of the resources for the data.

As such, by allowing the UE 115-a to select the vCell 210 (e.g., selecting a combination of serving cells 205), the UE 115-a may experience a reduction to the overall latency. For example, the UE 115-a and the network entity 105 may communicate the measurements and signaling related to SCell configuration in parallel (e.g., via multiple serving cells 205) and as part of cell selection. Accordingly, with access to the vCell 210, the UE 115-a may be ready to communicate (e.g., transmit or receive) via each serving cell 205 within a vCell 210 in response to entering the connected state (e.g., the RRC connected state).

In some cases, the UE 115-a may utilize the vCell 210 during a RACH procedure (e.g., initial access, access procedures) to reduce latency and improve efficiency. For example, the UE 115-a (or the network entity 105) may leverage each serving cell 205 (e.g., each band) of a vCell 210 starting from the RACH procedure, where the UE 115-a may select a vCell 210 that includes serving cells 205 associated with improved uplink communications and include serving cells 205 associated with improved downlink communications.

As an illustrative example, the UE 115-a may transmit uplink messages (e.g., message 1, message 3, or message A) of the RACH procedure using a first set of serving cells 205 of the vCell 210 that are associated with frequency division duplexing (FDD) (e.g., lower frequency bands), while the UE 115-a may receive downlink messages (e.g., message 2, message 4, or message B) of the RACH procedure using a second set of serving cells of the vCell 210 that are associated with time division duplexing (TDD).

In such cases, FDD bands may be more efficient for uplink communications rather than TDD bands due to a smaller subcarrier spacing of FDD bands (e.g., improved coverage areas), due to unrestricted slot formats allowing for lower latency and more efficient repetition handling, and due to increased network energy efficiency while monitoring for the uplink messages (e.g., RACH monitoring in FDD verse TDD), among other examples.

Additionally, in some cases, the FDD bands may be more efficient for uplink communications rather than TDD bands due to the UE 115-a being able to achieve a relatively increased output power in FDD bands relative to TDD bands, which may depend on a transmission chain of the UE 115-a (e.g., 1 power amplifier (PA) associated with 26 dBm gain in FDD vs. two PAs associated with 23 dBm gain each in TDD). Further PAs in relatively higher bands (e.g., TDD bands) may not be efficient. Accordingly, selecting a transmission chain may become increasingly complex for a UE 115 including 4 transmission chains (e.g., 4Tx UEs).

Further, in both uplink and downlink communications, the UE 115-a may benefit from flexibility in selecting the serving cells 205 of the vCell 210, which may reduce complexity of radio frequency management, affect placement of antennas and managing exposure, and affect the total power considerations for uplink communications. For example, because power class is defined as the aggregated power across serving cells 205 (e.g., sub-bands or bands), the UE 115-a may decide which bands to aggregate to be able to more efficiently handle exposures (e.g., maximum permissible exposures (MPEs) or Specific Absorption Rate).

In some cases, a serving cell 205 may transmit SI to the UE 115-a via a SI block 1 (SIB1) message, where the SI may include an initial downlink BWP for the serving cell 205, an initial uplink BWP for the serving cell 205, a timing advance, a TDD pattern, frequency information, among other examples. In such cases, the SI (e.g., parameters or configuration within the SI) may be defined for the serving cell 205 (e.g., a single serving cell) or defined for each CC of a serving cell (in the case of supplementary uplink (SUL)).

However, unlike a serving cell 205, a vCell 210 may include (e.g., be composed of) multiple serving cells 205, where each of the serving cells 205 may have different configurations of SI. For example, the serving cell 205-b of the vCell 210 may have a first TDD pattern or a first timing advance, while the serving cell 205-c of the vCell 210 may have a second TDD pattern or a second timing advance. As another example, a network entity 105 may schedule (e.g., define) downlink BWPs, uplink BWPs, or both, that are spread across multiple serving cells 205. Thus, techniques may be desired to indicate SI for a vCell 210 in the wireless communications system 200.

In accordance with the techniques described herein, the UE 115-a may receive SI 220 that is formatted for the vCell 210. For example, the UE 115-a may receive control signaling 215 (e.g., master information block (MIB) or other signaling) that indicates resources for receiving the SI 220 (e.g., SIB1).

The UE 115-a may monitor the resources to receive the SI 220, where the SI 220 may include IEs that are specific to each serving cell 205 within the vCell 210 (e.g., frequency resource specific or serving cell specific) and include IEs that are common across two or more serving cells 205 of the vCell 210 (e.g., vCell specific IEs). In such examples, a single serving cell 205 of the vCell 210 may transmit the SI 220 to the UE 115-a via the resources. Alternatively, two or more serving cells 205 of the vCell 210 may transmit the SI 220 to the UE 115-a via the resources.

To indicate the parameters for serving cell specific IEs, the SI 220 may include the identity of the serving cell 205 for each serving cell-specific IE, where the identity of the serving cell 205 may be a physical cell ID (PCID), absolute radio frequency channel number (ARFCN), a sub-band ID, a cell ID, a CC ID, or a combination of such IDs.

That is, the SI 220 may include a first IE associated with a parameter (e.g., configuration), where the first parameter may be different for (e.g., specific to) each serving cell 205 of the vCell 210. Accordingly, the first IE of the SI 220 may include a list of entries, where each entry of the list includes a mapping between an ID (ID) of a respective serving cell 205 and the associated first parameter.

As an illustrative example, the SI 220 may include a first IE associated with a synchronization signal (SS)-physical broadcast channel block (PBCH)-block power parameter. Accordingly, because the vCell 210 may be associated with multiple serving cells 205, the first IE may include a list of entries (e.g., values) for the SS-PBCH-block power, rather than a single entry. As such, a first entry of the first IE may include a mapping between the serving cell 205-b and the SS-PBCH-block power for the serving cell 205-b (e.g., (SS-PBCH-Block Power, ID of the serving cell 205-b)), while a second entry of the first IE may include a mapping between the serving cell 205-c and the SS-PBCH-block power for the serving cell 205-c (e.g., (SS-PBCH-Block Power, ID of the serving cell 205-b)).

Similarly, the SI 220 may include a second IE associated with TDD patterns. Accordingly, the second IE may include a list of entries for the TDD pattern, where a first entry of the list may include a mapping between the serving cell 205-b and the TDD pattern for the serving cell 205-b and a second entry in the list may include a mapping between the serving cell 205-d and the TDD pattern for the serving cell 205-d.

In some examples, a parameter of a serving cell specific IE may be common between two or more of the serving cells 205 of the vCell 210. In such examples, the SI 220 may include multiple identities of serving cells 205 for serving cell specific IEs that are identical among them. That is, within the list of entries for a serving cell-specific IE, a single entry may map two or more serving cells 205 to a same parameter, such that the same parameter may be common across the two or more serving cells.

As an illustrative example, the serving cells 205-b and 205-d may have a same TDD pattern due to the serving cells 205-b and 205-d operating within intra-band frequency resources. Accordingly, instead of having two entries within the TDD pattern IE (e.g., (TDD Pattern, ID of serving cell 205-b), (TDD Pattern, ID of serving cell 205-d), the SI 220 may include a single entry that maps the IDs of the serving cells 205-b and 205-d to the same TDD pattern (e.g., (TDD pattern, ID of serving cell 205-b, ID of serving cell 205-d)). In this way, the network may indicate the parameters of serving cell specific IEs more efficiently.

In some examples, one or more serving cells 205 of the vCell 210 may operate as independent serving cells 205 in addition to operating as part of the vCell 210, such that UEs 115 may choose to connect to the network via a single serving cell 205 rather than via the vCell 210. Accordingly, such serving cells 205 may additionally transmit SI 230 for independent operation. For example, in addition to operating as part of the vCell 210, the serving cell 205-d may operate independently and separately from the vCell 210. Accordingly, the serving cell 205-d may transmit SI 230 (e.g., second SI).

In such examples, one or more parameters of the SI 230 may be identical to those in the SI 220 of the vCell 210 (e.g., in cases where the vCell 210 might be reusing some components of the serving cell 205, such as synchronization signal blocks (SSBs)). Accordingly, to reduce the overhead of the SI 220, the SI 220 may include one or more flags to indicate whether the serving cell specific IEs of the SI 220 are identical to the corresponding IEs of the SI 230 from the serving cell 205-d that is operating independently.

As an illustrative example, the SI 230 may include a first IE associated with the TDD pattern, where the first IE indicates a first TDD pattern for the serving cell 205-d. Accordingly, the SI 220 may include a flag that indicates the TDD pattern for the serving cell 205-d is equivalent to the first TDD pattern indicated in the SI 230. In such examples, the flag may be included in the entry of the TDD pattern IE associated with the serving cell 205-d.

As described herein, vCell specific SI (e.g., downlink and uplink config common SIBs) may include information for two or more of the serving cells 205 of the vCell 210, as opposed to serving cell specific SI. As such, the vCell specific SI may be defined across the serving cells 205 of the vCell 210. For example, the SI 220 may include an IE associated with the initial downlink BWP of the vCell 210.

In one example, the initial downlink BWP may be defined as one contiguous BWP in a single serving cell 205 of the vCell 210 (e.g., the vCell 210 includes a single serving cell 205). In another example, the initial downlink BWP may be defined as a noncontiguous BWP spread over multiple serving cells of the vCell 210. In such examples, the UE 115-a or the serving cells 205 of the vCell may communicate a transport block (TB) via the whole noncontiguous BWP. In another example, the initial downlink BWP may be defined as a noncontiguous BWP spread over multiple serving cells 205 of the vCell 210, where each portion of the BWP may be utilized for different purposes. For example, downlink and uplink RACH messages may be communicated over different serving cells 205 of vCell 210, or each message of the RACH procedure may be communicated over a respective serving cell 205 of the vCell 210.

In SI for a single cell, downlink and uplink configuration common SI may be defined such that the UE 115-a may perform RACH procedures in two BWPs, one for uplink and one for downlink. In such cases, there may not be any distinction between resources for such RACH procedures. That is, in some other wireless communications systems, the UE 115-a may perform a RACH procedure with a single serving cell 205, however, using a vCell 210, the UE may communicate across different bandwidths and different serving cells for the RACH procedure. For example, RACH messages 2 and 4 may be communicated via a first set of serving cells 205 of the vCell 210, while RACH messages 1 and 3 may be communicated via a second set of serving cells 205 of the vCell. Accordingly, if the network intends to send and receive different RACH messages over different serving cells 205 of a vCell 210, SI for independent serving cells 205 may not support such functionality nor provide such flexibility.

Accordingly, in addition to the serving cell specific IEs, the SI 220 may include a vCell specific IE that is associated with parameter, where the parameter is common across two or more serving cells 205 of the vCell. In such examples, to identify the two or more serving cells 205 associated with the common parameter, the SI 220 may include the ID (or index) of the two or more serving cells 205 within the vCell specific IE. That is, the vCell specific IE may include a mapping between the parameter and the IDs of the two or more serving cells associated with the parameter.

As an illustrative example, the SI 220 may include a downlink configuration common IE (e.g., a first vCell specific IE) and include an uplink configuration common IE (e.g., a second vCell specific IE). In such examples, the downlink configuration common IE may include an initial downlink BWP (e.g., BWP-DownlinkCommon), while the uplink configuration common IE may include an initial uplink BWP (BWP-UplinkCommon).

As such, if the serving cells 205-b and 205-c of the vCell 210 are associated with uplink communications (e.g., FDD or lower bands), the uplink configuration common IE may map the IDs of the serving cells 205-b and 205-c to the initial uplink BWP IE. Similarly, if the serving cells 205-d and 205-d are associated with downlink communications (e.g., TDD or larger bandwidths), the downlink configuration common IE may map the IDs of the serving cells 205-d and 205-e to the initial downlink BWP IE.

By doing so, the UE 115-a may receive downlink messages (e.g., downlink RACH messages) and transmit uplink messages (e.g., uplink RACH messages) via different serving cells 205 of the vCell 210, which may ensure that such uplink messages are communicated via low-band FDD serving cells 205, while keeping the downlink messages communicated via TDD bands with larger bandwidths, thereby ensuring a more reliable frequency resource with improved coverage in both uplink and downlink communications.

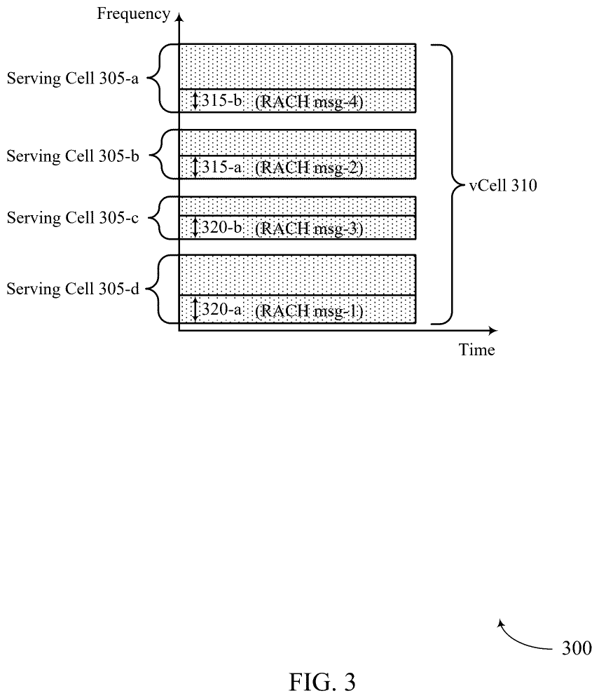

In such examples, the UE 115-a may utilize the vCell specific IEs to identify the serving cells 205 to use during a RACH procedure to access the vCell 210, which may be further described herein with reference to FIG. 3.

FIG. 3 shows an example of a resource diagram 300 that supports SI for vCells in wireless communications systems in accordance with one or more aspects of the present disclosure. The resource diagram 300 may be implemented by aspects of the wireless communications system 100 and the wireless communications system 200, as described herein with reference to FIGS. 1 and 2.

For example, the resource diagram 300 may be implemented by a UE 115 (not shown), which may be an example of the UE 115-a. Additionally, the resource diagram 300 may be implemented by one or more serving cells 305 of a vCell 310, which may be examples of the serving cells 205 of the vCell 210, as described herein with reference to FIG. 2. The techniques described in the context of the resource diagram 300 may enable the UE 115-a to receive SI (e.g., SI 220) that indicates resources for performing a RACH procedure with serving cells 305 of a vCell 310.

As described herein with reference to FIG. 2, the UE 115 may receive SI that includes vCell specific IEs. For example, the SI may include a downlink configuration common IE (e.g., a first vCell specific IE), where the initial downlink BWP IE of the downlink configuration common IE may be mapped to two or more serving cells 305, such as the serving cells 305-a and 305-b, of the vCell 310. Similarly, the SI may include an uplink configuration common IE (e.g., a second vCell specific IE), where the initial uplink BWP IE of the uplink configuration common IE may be mapped to two or more serving cells 305, such as the serving cells 305-c and 305-d of the vCell 310.

In such cases, however, it may be beneficial to obtain additional flexibility for distinguishing between the serving cells 305 for different downlink RACH messages 315, such as a RACH message 315-a (e.g., message 2) and a RACH message 315-b (e.g., message 4), and for different uplink RACH messages 320, such as a RACH message 320-a (e.g., message 1) and a RACH message 320-b (e.g., message 3).

To obtain such flexibility, the SI for the vCell 310 may include separate IEs, each associated with a different RACH step, within the downlink configuration common and the uplink configuration common to indicate the serving cells 305 (e.g., resources) utilized for each RACH step. Accordingly, if different serving cells 305 are indicated for different RACH steps, the SI may also include the ID of the serving cells 305, such that the network entity 105 may be able to differentiate the uplink RACH messages 320 and the downlink RACH message 315.

For example, the initial downlink BWP IE may include a generic parameters IE (e.g., genericParameters), a PDCCH configuration (e.g., pdcch-ConfigCommon), and a PDSCH configuration (e.g., pdsch-ConfigCommon). Accordingly, to indicate the serving cells 305 for the downlink RACH messages 315, the initial downlink BWP IE may be extended to be a sequence, such that the initial downlink BWP IE includes multiple generic parameters (e.g., BWPs), PDCCH configurations, and PDSCH configurations one for each downlink RACH message 3 15. Accordingly, inside the PDCCH and PDSCH configurations, the network entity 105 may indicate which serving cell 305 is allocated for each downlink RACH message 315.

Similarly, the initial uplink BWP IE may include a generic parameters IE (e.g., genericParameters), a RACH configuration IE (e.g., rach-ConfigCommon), a PUSCH configuration (e.g., pusch-ConfigCommon), and a PUCCH configuration (e.g., pucch-ConfigCommon). Accordingly, to indicate the serving cells 305 for the uplink RACH messages 320, the initial uplink BWP IE may be extended to be a sequence, such that the initial uplink BWP IE includes multiple generic parameters (e.g., BWPs), PUCCH configurations, PUSCH configurations, and RACH configurations, one for each uplink RACH message 320. Accordingly, inside the PUCCH, PUSCH, or RACH configurations, the network entity 105 may indicate which serving cell 305 is allocated for each uplink RACH message 320.

As an illustrative example, the vCell 310 may include the serving cells 305-a, 305-b, 305-c, and 305-d. Accordingly, the SI may indicate, via a first IE (e.g., a first PDCCH or PDSCH configuration of the initial downlink BWP IE), that the RACH message 315-a is to be transmitted via the serving cell 305-b. Similarly, the SI may indicate, via a second IE (e.g., a second PDCCH or PDSCH configuration of the initial downlink BWP IE), that the RACH message 315-b is to be transmitted via the serving cell 305-a.

The SI may also indicate, via a third IE (e.g., a first PUCCH, PUSCH, or RACH configuration of the initial uplink BWP IE), that the RACH message 320-a is to be transmitted via the serving cell 305-d. Similarly, the SI may also indicate, via a fourth IE (e.g., a second PUCCH, PUSCH, or RACH configuration of the initial uplink BWP IE), that the RACH message 320-b is to be transmitted via the serving cell 305-c.

In some other examples, the SI may include a respective initial downlink BWP IE for each downlink RACH message 315, where each initial downlink BWP IE may indicate which serving cell 305 is associated with the corresponding downlink RACH message 315. Similarly, the SI may include a respective initial uplink BWP IE for each uplink RACH message 320, where each initial uplink BWP IE may indicate which serving cell 305 is associated with the corresponding uplink RACH message 320.

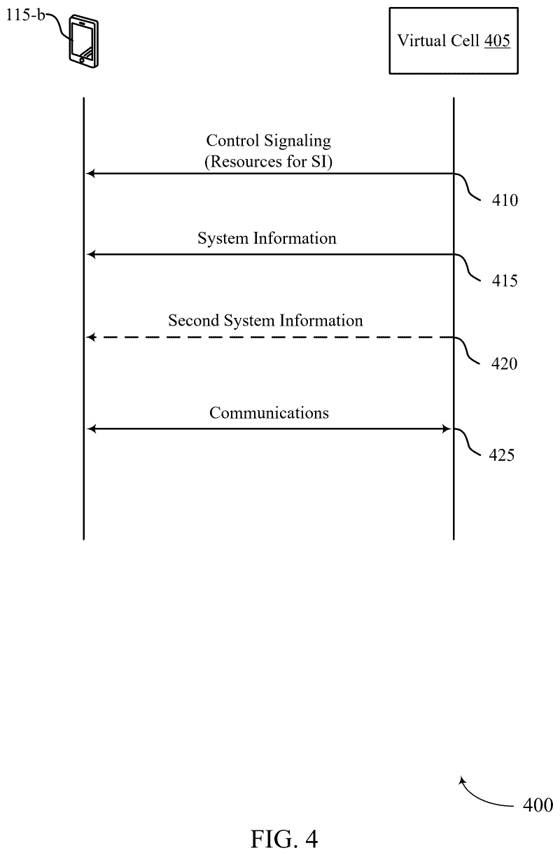

FIG. 4 shows an example of a process flow 400 that supports SI for vCells in wireless communications systems in accordance with one or more aspects of the present disclosure. Aspects of the process flow 400 may implement, or be implemented by, aspects of the wireless communications system 100, the wireless communications system 200, and the resource diagram 300, as described herein with reference to FIGS. 1 through 3. For example, the process flow 400 may be implemented by a UE 115-a, which may be an example of a UE 115-a, and implemented by a vCell 405, which may be an example of a vCell 210 and a vCell 310. The techniques described in the context of the process flow 400 may enable the UE 115-a to receive SI for the vCell 405.

At control signaling operations 410, the UE 115-b may receive control signaling that indicates one or more resources for reception of SI (e.g., SI 220) associated with the vCell 405. The control signaling operations 410 may be further described herein with reference to FIG. 2.

At SI operations 415, the UE 115-b may receive the SI via the one or more resources. In such examples, the SI may include one or more serving cell specific IEs, which may be further described herein with reference to FIG. 2. Additionally, the SI may include one or more vCell specific IEs, which may be further described herein with reference to FIGS. 2 and 3.

At second SI operations 420, the UE 115-b may receive, from a first serving cell of the vCell 405, second SI (e.g., SI 230) usable for communicating with the first serving cell individually and separately from the vCell 405, which may be further described herein with reference to FIG. 2. In some examples, the second SI operations 420 may be performed prior to, or simultaneously with, the SI operations 415.

At communication operations 425 the UE 115-b may communicate with the vCell 405 according to the parameters indicated via the SI.

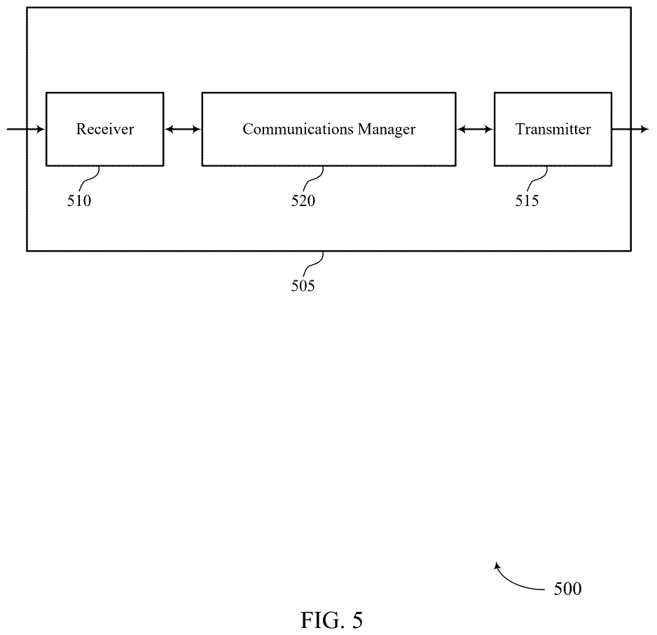

FIG. 5 shows a block diagram 500 of a device 505 that supports SI for vCells in wireless communications systems in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to SI for vCells in wireless communications systems). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to SI for vCells in wireless communications systems). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of SI for vCells in wireless communications systems as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving control signaling that indicates one or more resources for reception of SI associated with a vCell, where the vCell includes a set of serving cells that are grouped together to facilitate wireless communication. The communications manager 520 is capable of, configured to, or operable to support a means for receiving the SI via the one or more resources, where the SI includes a first IE associated with a first parameter that is specific to at least one serving cell of the set of serving cells, and a second IE associated with a second parameter that is common across two or more serving cells of the set of serving cells. The communications manager 520 is capable of, configured to, or operable to support a means for communicating via the set of serving cells of the vCell in accordance with the SI.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for communicating SI for vCells, which may lead to reduced processing, reduced power consumption, and a more efficient utilization of communication resources.

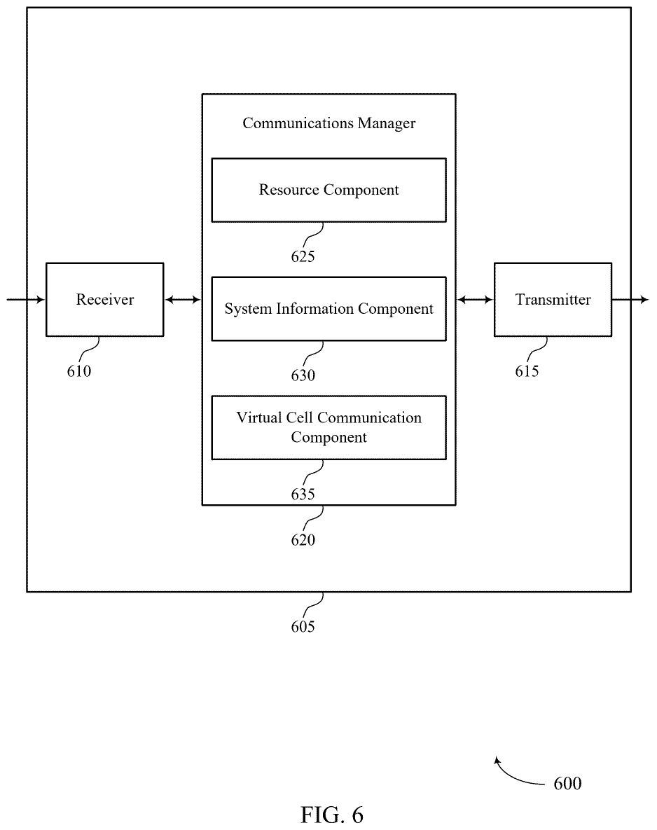

FIG. 6 shows a block diagram 600 of a device 605 that supports SI for vCells in wireless communications systems in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to SI for vCells in wireless communications systems). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to SI for vCells in wireless communications systems). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of SI for vCells in wireless communications systems as described herein. For example, the communications manager 620 may include a resource component 625, a SI component 630, a vCell communication component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The resource component 625 is capable of, configured to, or operable to support a means for receiving control signaling that indicates one or more resources for reception of SI associated with a vCell, where the vCell includes a set of serving cells that are grouped together to facilitate wireless communication. The SI component 630 is capable of, configured to, or operable to support a means for receiving the SI via the one or more resources, where the SI includes a first IE associated with a first parameter that is specific to at least one serving cell of the set of serving cells, and a second IE associated with a second parameter that is common across two or more serving cells of the set of serving cells. The vCell communication component 635 is capable of, configured to, or operable to support a means for communicating via the set of serving cells of the vCell in accordance with the SI.

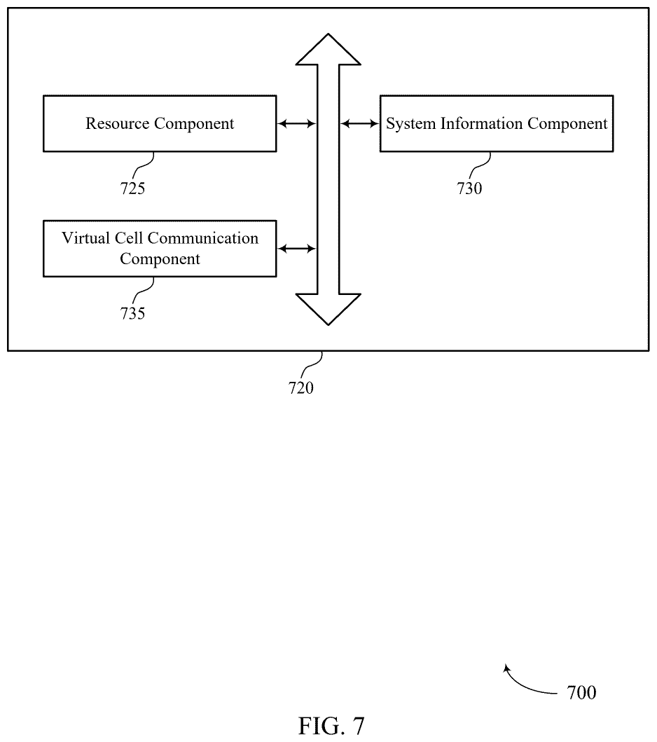

FIG. 7 shows a block diagram 700 of a communications manager 720 that supports SI for vCells in wireless communications systems in accordance with one or more aspects of the present disclosure. The communications manager 720 may be an example of aspects of a communications manager 520, a communications manager 620, or both, as described herein. The communications manager 720, or various components thereof, may be an example of means for performing various aspects of SI for vCells in wireless communications systems as described herein. For example, the communications manager 720 may include a resource component 725, a SI component 730, a vCell communication component 735, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The resource component 725 is capable of, configured to, or operable to support a means for receiving control signaling that indicates one or more resources for reception of SI associated with a vCell, where the vCell includes a set of serving cells that are grouped together to facilitate wireless communication. The SI component 730 is capable of, configured to, or operable to support a means for receiving the SI via the one or more resources, where the SI includes a first IE associated with a first parameter that is specific to at least one serving cell of the set of serving cells, and a second IE associated with a second parameter that is common across two or more serving cells of the set of serving cells. The vCell communication component 735 is capable of, configured to, or operable to support a means for communicating via the set of serving cells of the vCell in accordance with the SI.

In some examples, the first IE includes a list of entries. In some examples, each entry of the list of entries includes a mapping between the first parameter and an ID of a respective serving cell of the set of serving cells.

In some examples, the ID of the respective serving cell includes a PCID, an ARFN, a sub-band ID, a CC ID, or a cell ID.

In some examples, a first entry in the list of entries includes a mapping between the first parameter and respective IDs of multiple serving cells of the set of serving cells. In some examples, the first parameter is common across the multiple serving cells.

In some examples, the SI component 730 is capable of, configured to, or operable to support a means for receiving, from a first serving cell of the set of serving cells, second SI usable for communications with the first serving cell individually and separately from the vCell.

In some examples, the SI includes a flag that indicates that the first parameter for the first serving cell is equivalent to a third parameter of the second SI.

In some examples, the second IE includes a mapping between the second parameter and respective IDs for the two or more serving cells of the set of serving cells.

In some examples, the SI includes a third IE associated with a third parameter for a first step of a random-access procedure between the UE and the vCell, a fourth IE associated with a fourth parameter for a second step of the random-access procedure, a fifth IE associated with a fifth parameter for a third step of the random-access procedure, and a sixth IE associated with a sixth parameter for a fourth step of the random-access procedure.

In some examples, the third IE further includes a mapping between the third parameter and one or more first serving cells of the set of serving cells, the fourth IE further includes a mapping between the fourth parameter and one or more second serving cells of the set of serving cells, the fifth IE includes a mapping between the fifth parameter and one or more third serving cells of the set of serving cells, and the sixth IE includes a mapping between the sixth parameter and one or more fourth serving cells of the set of serving cells.

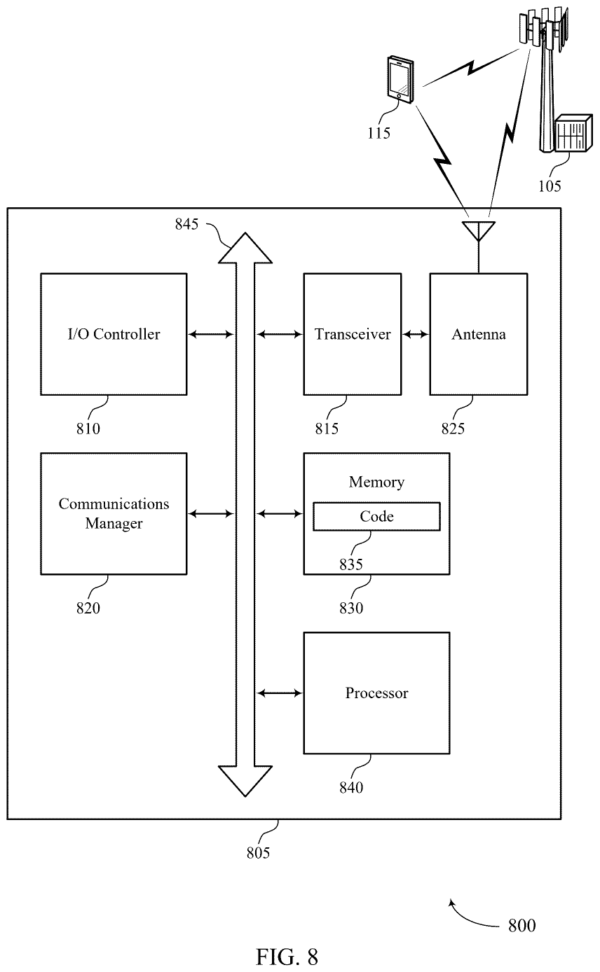

FIG. 8 shows a diagram of a system 800 including a device 805 that supports SI for vCells in wireless communications systems in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting SI for vCells in wireless communications systems). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving control signaling that indicates one or more resources for reception of SI associated with a vCell, where the vCell includes a set of serving cells that are grouped together to facilitate wireless communication. The communications manager 820 is capable of, configured to, or operable to support a means for receiving the SI via the one or more resources, where the SI includes a first IE associated with a first parameter that is specific to at least one serving cell of the set of serving cells, and a second IE associated with a second parameter that is common across two or more serving cells of the set of serving cells. The communications manager 820 is capable of, configured to, or operable to support a means for communicating via the set of serving cells of the vCell in accordance with the SI.

By including or configuring the communications manager 820 in accordance with examples as described herein, the device 805 may support techniques for communicating SI for vCells, which may lead to improved communication reliability, reduced latency, improved user experience related to reduced processing, reduced power consumption, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of SI for vCells in wireless communications systems as described herein, or the at least one processor 840 and the at least one memory 830 may be otherwise configured to, individually or collectively, perform or support such operations.

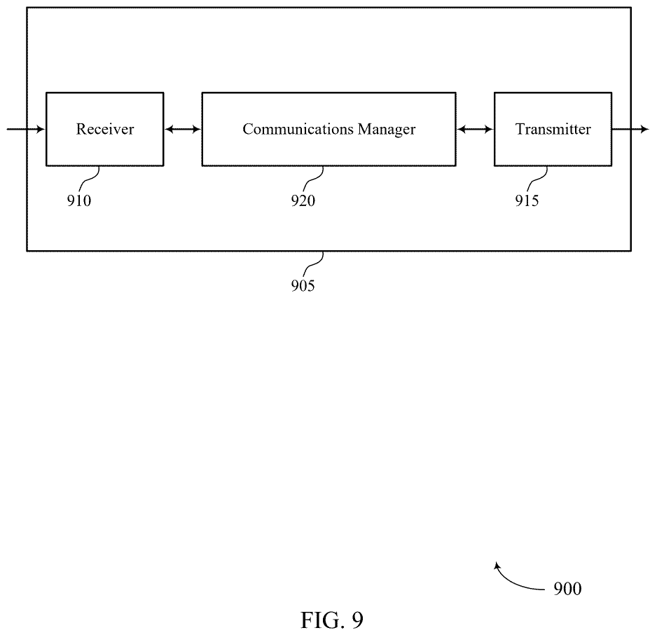

FIG. 9 shows a block diagram 900 of a device 905 that supports SI for vCells in wireless communications systems in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of SI for vCells in wireless communications systems as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting control signaling that indicates one or more resources for reception of SI associated with a vCell, where the vCell includes a set of serving cells that are grouped together to facilitate wireless communications between the network entity and a UE. The communications manager 920 is capable of, configured to, or operable to support a means for transmitting the SI via the one or more resources, where the SI includes a first IE associated with a first parameter that is specific to at least one serving cell of the set of serving cells and a second IE associated with a second parameter that is common across two or more serving cells of the set of serving cells of the vCell. The communications manager 920 is capable of, configured to, or operable to support a means for communicating via the set of serving cells of the vCell in accordance with the SI.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for communicating SI for vCells, which may lead to reduced processing, reduced power consumption, and a more efficient utilization of communication resources.

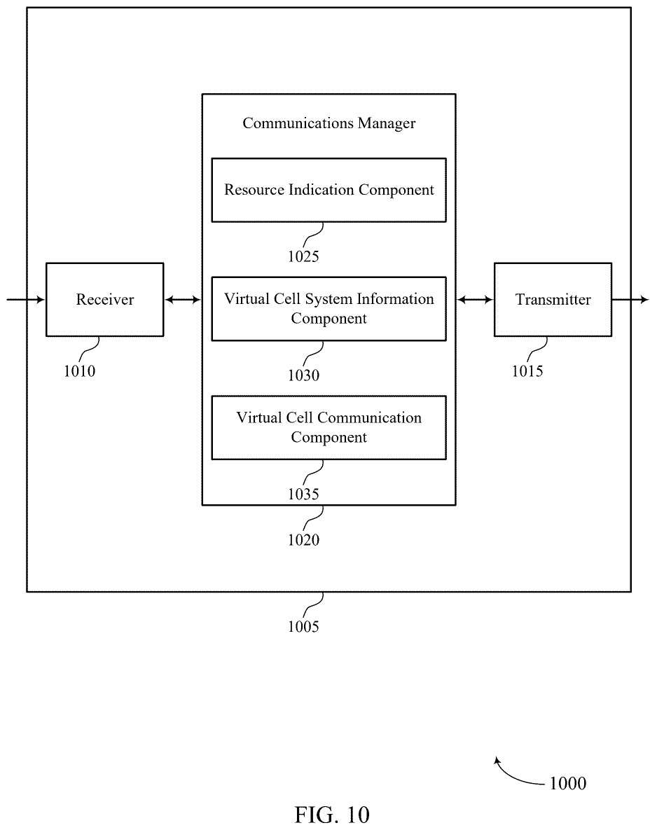

FIG. 10 shows a block diagram 1000 of a device 1005 that supports SI for vCells in wireless communications systems in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of SI for vCells in wireless communications systems as described herein. For example, the communications manager 1020 may include a resource indication component 1025, a vCell SI component 1030, a vCell communication component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The resource indication component 1025 is capable of, configured to, or operable to support a means for transmitting control signaling that indicates one or more resources for reception of SI associated with a vCell, where the vCell includes a set of serving cells that are grouped together to facilitate wireless communications between the network entity and a UE. The vCell SI component 1030 is capable of, configured to, or operable to support a means for transmitting the SI via the one or more resources, where the SI includes a first IE associated with a first parameter that is specific to at least one serving cell of the set of serving cells and a second IE associated with a second parameter that is common across two or more serving cells of the set of serving cells of the vCell. The vCell communication component 1035 is capable of, configured to, or operable to support a means for communicating via the set of serving cells of the vCell in accordance with the SI.

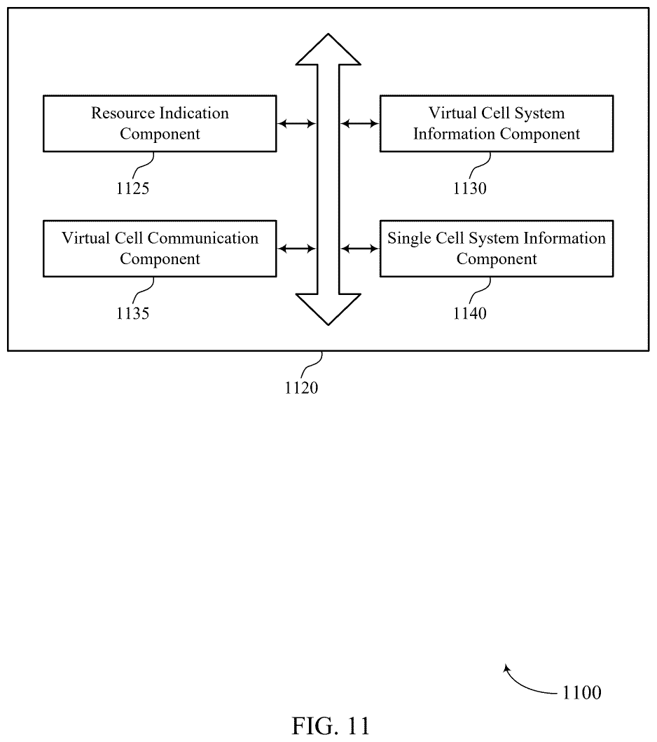

FIG. 11 shows a block diagram 1100 of a communications manager 1120 that supports SI for vCells in wireless communications systems in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of SI for vCells in wireless communications systems as described herein. For example, the communications manager 1120 may include a resource indication component 1125, a vCell SI component 1130, a vCell communication component 1135, a single cell SI component 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The resource indication component 1125 is capable of, configured to, or operable to support a means for transmitting control signaling that indicates one or more resources for reception of SI associated with a vCell, where the vCell includes a set of serving cells that are grouped together to facilitate wireless communications between the network entity and a UE. The vCell SI component 1130 is capable of, configured to, or operable to support a means for transmitting the SI via the one or more resources, where the SI includes a first IE associated with a first parameter that is specific to at least one serving cell of the set of serving cells and a second IE associated with a second parameter that is common across two or more serving cells of the set of serving cells of the vCell. The vCell communication component 1135 is capable of, configured to, or operable to support a means for communicating via the set of serving cells of the vCell in accordance with the SI.

In some examples, the first IE includes a list of entries. In some examples, each entry of the list of entries includes a mapping between the first parameter and an ID of a respective serving cell of the set of serving cells.

In some examples, the ID of the respective serving cell includes a PCID, an ARFN, a sub-band ID, a CC ID, or a cell ID.

In some examples, a first entry in the list of entries includes a mapping between the first parameter and respective IDs of multiple serving cells of the set of serving cells. In some examples, the first parameter is common across the multiple serving cells.

In some examples, the single cell SI component 1140 is capable of, configured to, or operable to support a means for transmitting, via a first serving cell of the set of serving cells, second SI usable for communicating with the first serving cell individually and separately from the vCell.

In some examples, the SI includes a flag that indicates that the first parameter for the first serving cell is equivalent to a third parameter of the second SI.

In some examples, the second IE includes a mapping between the second parameter and respective IDs for the two or more serving cells of the set of serving cells.

In some examples, the SI includes a third IE associated with a third parameter for a first step of a random-access procedure between the UE and the vCell, a fourth IE associated with a fourth parameter for a second step of the random-access procedure, a fifth IE associated with a fifth parameter for a third step of the random-access procedure, and a sixth IE associated with a sixth parameter for a fourth step of the random-access procedure.

In some examples, the third IE further includes a mapping between the third parameter and one or more first serving cells of the set of serving cells, the fourth IE further includes a mapping between the fourth parameter and one or more second serving cells of the set of serving cells, the fifth IE includes a mapping between the fifth parameter and one or more third serving cells of the set of serving cells, and the sixth IE includes a mapping between the sixth parameter and one or more fourth serving cells of the set of serving cells.

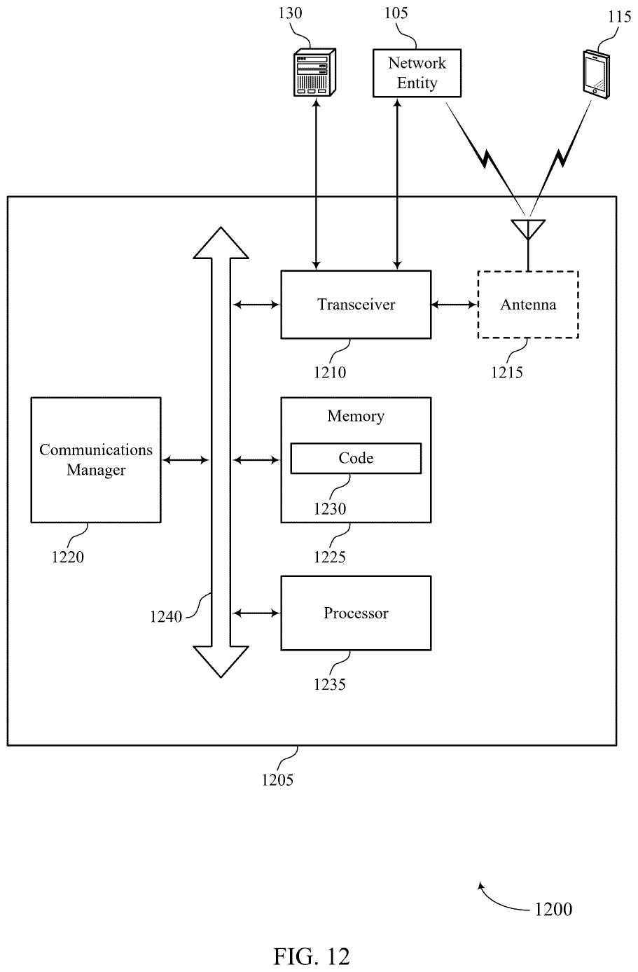

FIG. 12 shows a diagram of a system 1200 including a device 1205 that supports SI for vCells in wireless communications systems in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting SI for vCells in wireless communications systems). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting control signaling that indicates one or more resources for reception of SI associated with a vCell, where the vCell includes a set of serving cells that are grouped together to facilitate wireless communications between the network entity and a UE. The communications manager 1220 is capable of, configured to, or operable to support a means for transmitting the SI via the one or more resources, where the SI includes a first IE associated with a first parameter that is specific to at least one serving cell of the set of serving cells and a second IE associated with a second parameter that is common across two or more serving cells of the set of serving cells of the vCell. The communications manager 1220 is capable of, configured to, or operable to support a means for communicating via the set of serving cells of the vCell in accordance with the SI.

By including or configuring the communications manager 1220 in accordance with examples as described herein, the device 1205 may support techniques for communicating SI for vCells, which may lead to improved communication reliability, reduced latency, improved user experience related to reduced processing, reduced power consumption, more efficient utilization of communication resources, and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of SI for vCells in wireless communications systems as described herein, or the at least one processor 1235 and the at least one memory 1225 may be otherwise configured to, individually or collectively, perform or support such operations.

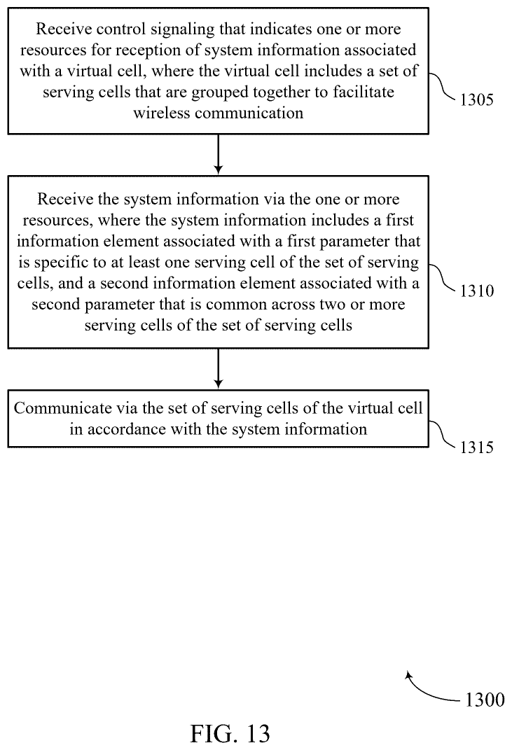

FIG. 13 shows a flowchart illustrating a method 1300 that supports SI for vCells in wireless communications systems in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving control signaling that indicates one or more resources for reception of SI associated with a vCell, where the vCell includes a set of serving cells that are grouped together to facilitate wireless communication. The operations of 1305 may be performed in accordance with examples as disclosed herein. In some examples, aspects of the operations of 1305 may be performed by a resource component 725 as described with reference to FIG. 7.

At 1310, the method may include receiving the SI via the one or more resources, where the SI includes a first IE associated with a first parameter that is specific to at least one serving cell of the set of serving cells, and a second IE associated with a second parameter that is common across two or more serving cells of the set of serving cells. The operations of 1310 may be performed in accordance with examples as disclosed herein. In some examples, aspects of the operations of 1310 may be performed by a SI component 730 as described with reference to FIG. 7.

At 1315, the method may include communicating via the set of serving cells of the vCell in accordance with the SI. The operations of 1315 may be performed in accordance with examples as disclosed herein. In some examples, aspects of the operations of 1315 may be performed by a vCell communication component 735 as described with reference to FIG. 7.

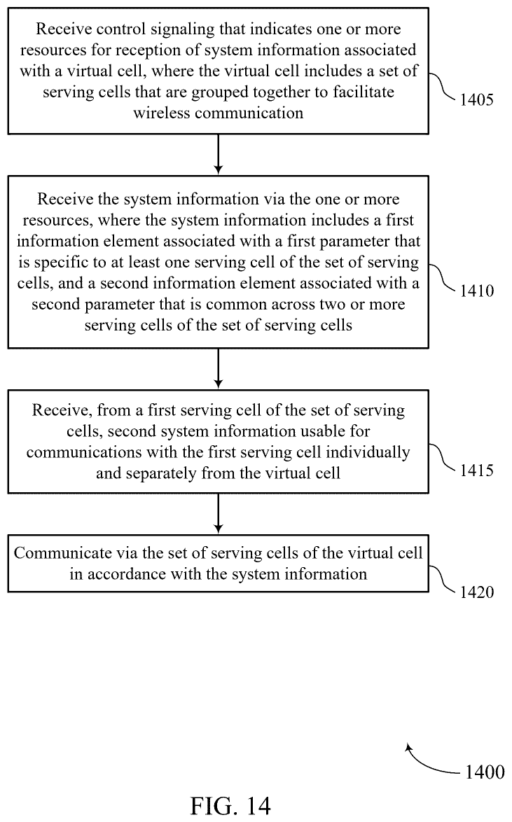

FIG. 14 shows a flowchart illustrating a method 1400 that supports SI for vCells in wireless communications systems in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving control signaling that indicates one or more resources for reception of SI associated with a vCell, where the vCell includes a set of serving cells that are grouped together to facilitate wireless communication. The operations of 1405 may be performed in accordance with examples as disclosed herein. In some examples, aspects of the operations of 1405 may be performed by a resource component 725 as described with reference to FIG. 7.

At 1410, the method may include receiving the SI via the one or more resources, where the SI includes a first IE associated with a first parameter that is specific to at least one serving cell of the set of serving cells, and a second IE associated with a second parameter that is common across two or more serving cells of the set of serving cells. The operations of 1410 may be performed in accordance with examples as disclosed herein. In some examples, aspects of the operations of 1410 may be performed by a SI component 730 as described with reference to FIG. 7.

At 1415, the method may include receiving, from a first serving cell of the set of serving cells, second SI usable for communications with the first serving cell individually and separately from the vCell. The operations of 1415 may be performed in accordance with examples as disclosed herein. In some examples, aspects of the operations of 1415 may be performed by a SI component 730 as described with reference to FIG. 7.

At 1420, the method may include communicating via the set of serving cells of the vCell in accordance with the SI. The operations of 1420 may be performed in accordance with examples as disclosed herein. In some examples, aspects of the operations of 1420 may be performed by a vCell communication component 735 as described with reference to FIG. 7.

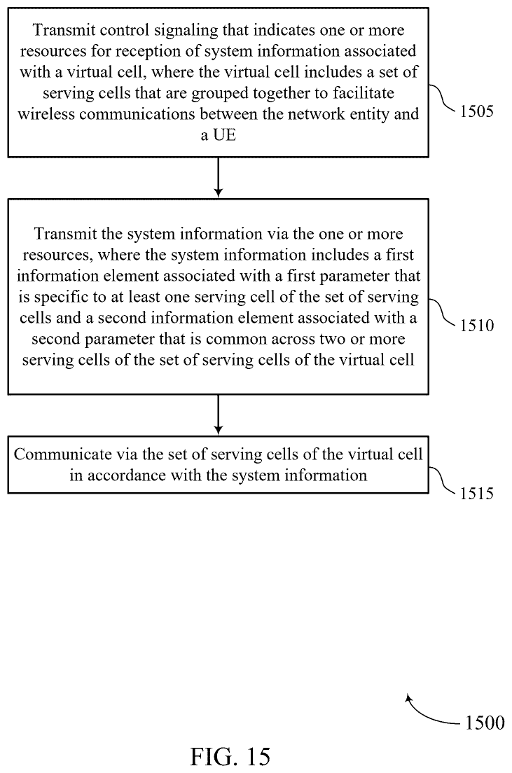

FIG. 15 shows a flowchart illustrating a method 1500 that supports SI for vCells in wireless communications systems in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting control signaling that indicates one or more resources for reception of SI associated with a vCell, where the vCell includes a set of serving cells that are grouped together to facilitate wireless communications between the network entity and a UE. The operations of 1505 may be performed in accordance with examples as disclosed herein. In some examples, aspects of the operations of 1505 may be performed by a resource indication component 1125 as described with reference to FIG. 11.

At 1510, the method may include transmitting the SI via the one or more resources, where the SI includes a first IE associated with a first parameter that is specific to at least one serving cell of the set of serving cells and a second IE associated with a second parameter that is common across two or more serving cells of the set of serving cells of the vCell. The operations of 1510 may be performed in accordance with examples as disclosed herein. In some examples, aspects of the operations of 1510 may be performed by a vCell SI component 1130 as described with reference to FIG. 11.

At 1515, the method may include communicating via the set of serving cells of the vCell in accordance with the SI. The operations of 1515 may be performed in accordance with examples as disclosed herein. In some examples, aspects of the operations of 1515 may be performed by a vCell communication component 1135 as described with reference to FIG. 11.

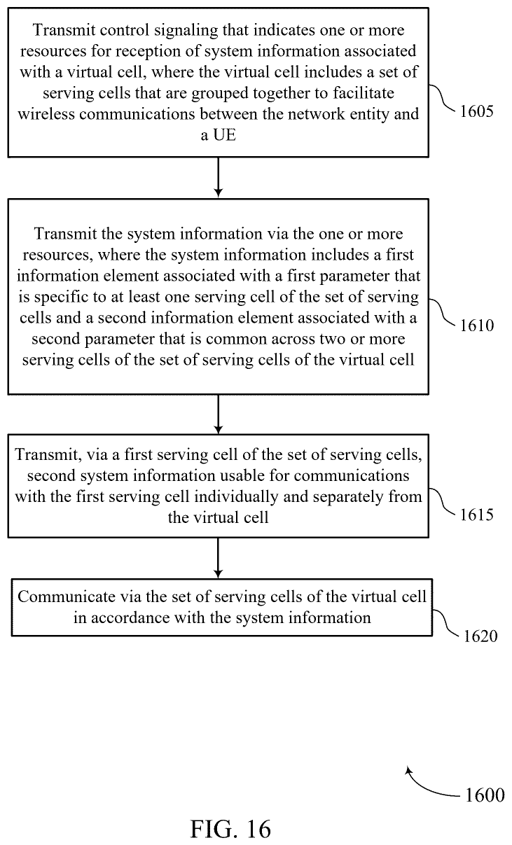

FIG. 16 shows a flowchart illustrating a method 1600 that supports SI for vCells in wireless communications systems in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting control signaling that indicates one or more resources for reception of SI associated with a vCell, where the vCell includes a set of serving cells that are grouped together to facilitate wireless communications between the network entity and a UE. The operations of 1605 may be performed in accordance with examples as disclosed herein. In some examples, aspects of the operations of 1605 may be performed by a resource indication component 1125 as described with reference to FIG. 11.

At 1610, the method may include transmitting the SI via the one or more resources, where the SI includes a first IE associated with a first parameter that is specific to at least one serving cell of the set of serving cells and a second IE associated with a second parameter that is common across two or more serving cells of the set of serving cells of the vCell. The operations of 1610 may be performed in accordance with examples as disclosed herein. In some examples, aspects of the operations of 1610 may be performed by a vCell SI component 1130 as described with reference to FIG. 11.

At 1615, the method may include transmitting, via a first serving cell of the set of serving cells, second SI usable for communicating with the first serving cell individually and separately from the vCell. The operations of 1615 may be performed in accordance with examples as disclosed herein. In some examples, aspects of the operations of 1615 may be performed by a single cell SI component 1140 as described with reference to FIG. 11.

At 1620, the method may include communicating via the set of serving cells of the vCell in accordance with the SI. The operations of 1620 may be performed in accordance with examples as disclosed herein. In some examples, aspects of the operations of 1620 may be performed by a vCell communication component 1135 as described with reference to FIG. 11.

The following provides an overview of aspects of the present disclosure:
Aspect 1: A method for wireless communications at a UE, comprising: receiving control signaling that indicates one or more resources for reception of SI associated with a vCell, wherein the vCell comprises a set of serving cells that are grouped together to facilitate wireless communication; receiving the SI via the one or more resources, wherein the SI comprises a first IE associated with a first parameter that is specific to at least one serving cell of the set of serving cells, and a second IE associated with a second parameter that is common across two or more serving cells of the set of serving cells; and communicating via the set of serving cells of the vCell in accordance with the SI.
Aspect 2: The method of aspect 1, wherein the first IE comprises a list of entries, and each entry of the list of entries comprises a mapping between the first parameter and an ID of a respective serving cell of the set of serving cells.
Aspect 3: The method of aspect 2, wherein the ID of the respective serving cell comprises a PCID, an ARFCN, a subband ID, a CC ID, or a cell ID.
Aspect 4: The method of any of aspects 2 through 3, wherein a first entry in the list of entries comprises a mapping between the first parameter and respective IDs of multiple serving cells of the set of serving cells, the first parameter is common across the multiple serving cells.
Aspect 5: The method of any of aspects 1 through 4, further comprising: receiving, from a first serving cell of the set of serving cells, second SI usable for communications with the first serving cell individually and separately from the vCell.
Aspect 6: The method of aspect 5, wherein the SI comprises a flag that indicates that the first parameter for the first serving cell is equivalent to a third parameter of the second SI.
Aspect 7: The method of any of aspects 1 through 6, wherein the second IE comprises a mapping between the second parameter and respective IDs for the two or more serving cells of the set of serving cells.
Aspect 8: The method of any of aspects 1 through 7, wherein the SI further comprises: a third IE associated with a third parameter for a first step of a random-access procedure between the UE and the vCell, a fourth IE associated with a fourth parameter for a second step of the random-access procedure, a fifth IE associated with a fifth parameter for a third step of the random-access procedure, and a sixth IE associated with a sixth parameter for a fourth step of the random-access procedure.
Aspect 9: The method of aspect 8, wherein the third IE further comprises a mapping between the third parameter and one or more first serving cells of the set of serving cells, the fourth IE further comprises a mapping between the fourth parameter and one or more second serving cells of the set of serving cells, the fifth IE comprises a mapping between the fifth parameter and one or more third serving cells of the set of serving cells, and the sixth IE comprises a mapping between the sixth parameter and one or more fourth serving cells of the set of serving cells.
Aspect 10: A method for wireless communications at a network entity, comprising: transmitting control signaling that indicates one or more resources for reception of SI associated with a vCell, wherein the vCell comprises a set of serving cells that are grouped together to facilitate wireless communications between the network entity and a UE; transmitting the SI via the one or more resources, wherein the SI comprises a first IE associated with a first parameter that is specific to at least one serving cell of the set of serving cells and a second IE associated with a second parameter that is common across two or more serving cells of the set of serving cells of the vCell; and communicating via the set of serving cells of the vCell in accordance with the SI.
Aspect 11: The method of aspect 10, wherein the first IE comprises a list of entries, and each entry of the list of entries comprises a mapping between the first parameter and an ID of a respective serving cell of the set of serving cells.
Aspect 12: The method of aspect 11, wherein the ID of the respective serving cell comprises a PCID, an ARFCN, a subband ID, a CC ID, or a cell ID.
Aspect 13: The method of any of aspects 11 through 12, wherein a first entry in the list of entries comprises a mapping between the first parameter and respective IDs of multiple serving cells of the set of serving cells, the first parameter is common across the multiple serving cells.
Aspect 14: The method of any of aspects 10 through 13, further comprising: transmitting, via a first serving cell of the set of serving cells, second SI usable for communicating with the first serving cell individually and separately from the vCell.
Aspect 15: The method of aspect 14, wherein the SI comprises a flag that indicates that the first parameter for the first serving cell is equivalent to a third parameter of the second SI.
Aspect 16: The method of any of aspects 10 through 15, wherein the second IE comprises a mapping between the second parameter and respective IDs for the two or more serving cells of the set of serving cells.
Aspect 17: The method of any of aspects 10 through 16, wherein the SI further comprises: a third IE associated with a third parameter for a first step of a random-access procedure between the UE and the vCell, a fourth IE associated with a fourth parameter for a second step of the random-access procedure, a fifth IE associated with a fifth parameter for a third step of the random-access procedure, and a sixth IE associated with a sixth parameter for a fourth step of the random-access procedure.
Aspect 18: The method of aspect 17, wherein the third IE further comprises a mapping between the third parameter and one or more first serving cells of the set of serving cells, the fourth IE further comprises a mapping between the fourth parameter and one or more second serving cells of the set of serving cells, the fifth IE comprises a mapping between the fifth parameter and one or more third serving cells of the set of serving cells, and the sixth IE comprises a mapping between the sixth parameter and one or more fourth serving cells of the set of serving cells.
Aspect 19: A UE for wireless communications, comprising one or more memories storing processor-executable code, and one or more processors coupled with the one or more memories and individually or collectively operable to execute the code to cause the UE to perform a method of any of aspects 1 through 9.
Aspect 20: A UE for wireless communications, comprising at least one means for performing a method of any of aspects 1 through 9.
Aspect 21: A non-transitory computer-readable medium storing code for wireless communications, the code comprising instructions executable by one or more processors to perform a method of any of aspects 1 through 9.
Aspect 22: A network entity for wireless communications, comprising one or more memories storing processor-executable code, and one or more processors coupled with the one or more memories and individually or collectively operable to execute the code to cause the network entity to perform a method of any of aspects 10 through 18.
Aspect 23: A network entity for wireless communications, comprising at least one means for performing a method of any of aspects 10 through 18.
Aspect 24: A non-transitory computer-readable medium storing code for wireless communications, the code comprising instructions executable by one or more processors to perform a method of any of aspects 10 through 18.

It should be noted that the methods described herein describe possible implementations. The operations and the steps may be rearranged, or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories that store processor-executable code; and
one or more processors coupled with the one or more memories and individually or collectively operable to execute the code to cause the UE to:
receive control signaling that indicates one or more resources for reception of system information associated with a virtual cell, wherein the virtual cell comprises a set of serving cells that are grouped together to facilitate wireless communication;
receive the system information via the one or more resources, wherein the system information comprises a first information element associated with a first parameter that is specific to at least one serving cell of the set of serving cells, and a second information element associated with a second parameter that is common across two or more serving cells of the set of serving cells; and
communicate via the set of serving cells of the virtual cell in accordance with the system information.

2. The UE of claim 1, wherein the first information element comprises a list of entries, and wherein each entry of the list of entries comprises a mapping between the first parameter and an identifier of a respective serving cell of the set of serving cells.

3. The UE of claim 2, wherein the identifier of the respective serving cell comprises a physical cell identifier, an absolute radio frequency channel number, a sub-band identifier, a component carrier identifier, or a cell identifier.

4. The UE of claim 2, wherein a first entry in the list of entries comprises a mapping between the first parameter and respective identifiers of multiple serving cells of the set of serving cells, and wherein the first parameter is common across the multiple serving cells.

5. The UE of claim 1, wherein the one or more processors are individually or collectively further operable to execute the code to cause the UE to:
receive, from a first serving cell of the set of serving cells, second system information usable for communications with the first serving cell individually and separately from the virtual cell.

6. The UE of claim 5, wherein the system information comprises a flag that indicates that the first parameter for the first serving cell is equivalent to a third parameter of the second system information.

7. The UE of claim 1, wherein the second information element comprises a mapping between the second parameter and respective identifiers for the two or more serving cells of the set of serving cells.

8. The UE of claim 1, wherein the system information comprises:
a third information element associate with a third parameter for a first step of a random-access procedure between the UE and the virtual cell,
a fourth information element associated with a fourth parameter for a second step of the random-access procedure,
a fifth information element associated with a fifth parameter for a third step of the random-access procedure, and
a sixth information element associated with a sixth parameter for a fourth step of the random-access procedure.

9. The UE of claim 8, wherein:
the third information element further comprises a mapping between the third parameter and one or more first serving cells of the set of serving cells,
the fourth information element further comprises a mapping between the fourth parameter and one or more second serving cells of the set of serving cells,
the fifth information element comprises a mapping between the fifth parameter and one or more third serving cells of the set of serving cells, and
the sixth information element comprises a mapping between the sixth parameter and one or more fourth serving cells of the set of serving cells.

10. A network entity, comprising:
one or more memories that store processor-executable code; and
one or more processors coupled with the one or more memories and individually or collectively operable to execute the code to cause the network entity to:
transmit control signaling that indicates one or more resources for reception of system information associated with a virtual cell, wherein the virtual cell comprises a set of serving cells that are grouped together to facilitate wireless communications between the network entity and a user equipment (UE);
transmit the system information via the one or more resources, wherein the system information comprises a first information element associated with a first parameter that is specific to at least one serving cell of the set of serving cells and a second information element associated with a second parameter that is common across two or more serving cells of the set of serving cells of the virtual cell; and
communicate via the set of serving cells of the virtual cell in accordance with the system information.

11. The network entity of claim 10, wherein the first information element comprises a list of entries, and wherein each entry of the list of entries comprises a mapping between the first parameter and an identifier of a respective serving cell of the set of serving cells.

12. The network entity of claim 11, wherein the identifier of the respective serving cell comprises a physical cell identifier, an absolute radio frequency channel number, a sub-band identifier, a component carrier identifier, or a cell identifier.

13. The network entity of claim 11, wherein a first entry in the list of entries comprises a mapping between the first parameter and respective identifiers of multiple serving cells of the set of serving cells, and wherein the first parameter is common across the multiple serving cells.

14. The network entity of claim 10, wherein the one or more processors are individually or collectively further operable to execute the code to cause the network entity to:
transmit, via a first serving cell of the set of serving cells, second system information usable for communications with the first serving cell individually and separately from the virtual cell.

15. The network entity of claim 14, wherein the system information comprises a flag that indicates that the first parameter for the first serving cell is equivalent to a third parameter of the second system information.

16. The network entity of claim 10, wherein the second information element comprises a mapping between the second parameter and respective identifiers for the two or more serving cells of the set of serving cells.

17. The network entity of claim 10, wherein the system information comprises:
a third information element associate with a third parameter for a first step of a random-access procedure between the UE and the virtual cell,
a fourth information element associated with a fourth parameter for a second step of the random-access procedure,
a fifth information element associated with a fifth parameter for a third step of the random-access procedure, and
a sixth information element associated with a sixth parameter for a fourth step of the random-access procedure.

18. The network entity of claim 17, wherein:
the third information element further comprises a mapping between the third parameter and one or more first serving cells of the set of serving cells,
the fourth information element further comprises a mapping between the fourth parameter and one or more second serving cells of the set of serving cells,
the fifth information element comprises a mapping between the fifth parameter and one or more third serving cells of the set of serving cells, and
the sixth information element comprises a mapping between the sixth parameter and one or more fourth serving cells of the set of serving cells.

19. A method for wireless communications at a user equipment (UE), comprising:
receiving control signaling that indicates one or more resources for reception of system information associated with a virtual cell, wherein the virtual cell comprises a set of serving cells that are grouped together to facilitate wireless communication;
receiving the system information via the one or more resources, wherein the system information comprises a first information element associated with a first parameter that is specific to at least one serving cell of the set of serving cells, and a second information element associated with a second parameter that is common across two or more serving cells of the set of serving cells; and
communicating via the set of serving cells of the virtual cell in accordance with the system information.

20. The method of claim 19, wherein the first information element comprises a list of entries, and wherein each entry of the list of entries comprises a mapping between the first parameter and an identifier of a respective serving cell of the set of serving cells.

21. The method of claim 20, wherein the identifier of the respective serving cell comprises a physical cell identifier, an absolute radio frequency channel number, a sub-band identifier, a component carrier identifier, or a cell identifier.

22. The method of claim 20, wherein a first entry in the list of entries comprises a mapping between the first parameter and respective identifiers of multiple serving cells of the set of serving cells, and wherein the first parameter is common across the multiple serving cells.

23. The method of claim 19, further comprising:
receiving, from a first serving cell of the set of serving cells, second system information usable for communications with the first serving cell individually and separately from the virtual cell.

24. The method of claim 23, wherein the system information comprises a flag that indicates that the first parameter for the first serving cell is equivalent to a third parameter of the second system information.

25. The method of claim 19, wherein the second information element comprises a mapping between the second parameter and respective identifiers for the two or more serving cells of the set of serving cells.

26. The method of claim 19, wherein the system information further comprises:
a third information element associated with a third parameter for a first step of a random-access procedure between the UE and the virtual cell,
a fourth information element associated with a fourth parameter for a second step of the random-access procedure,
a fifth information element associated with a fifth parameter for a third step of the random-access procedure, and
a sixth information element associated with a sixth parameter for a fourth step of the random-access procedure.

27. The method of claim 26, wherein:
the third information element further comprises a mapping between the third parameter and one or more first serving cells of the set of serving cells,
the fourth information element further comprises a mapping between the fourth parameter and one or more second serving cells of the set of serving cells,
the fifth information element comprises a mapping between the fifth parameter and one or more third serving cells of the set of serving cells, and
the sixth information element comprises a mapping between the sixth parameter and one or more fourth serving cells of the set of serving cells.

28. A method for wireless communications at a network entity, comprising:
transmitting control signaling that indicates one or more resources for reception of system information associated with a virtual cell, wherein the virtual cell comprises a set of serving cells that are grouped together to facilitate wireless communications between the network entity and a user equipment (UE);
transmitting the system information via the one or more resources, wherein the system information comprises a first information element associated with a first parameter that is specific to at least one serving cell of the set of serving cells and a second information element associated with a second parameter that is common across two or more serving cells of the set of serving cells of the virtual cell; and
communicating via the set of serving cells of the virtual cell in accordance with the system information.

29. The method of claim 28, wherein the first information element comprises a list of entries, and wherein each entry of the list of entries comprises a mapping between the first parameter and an identifier of a respective serving cell of the set of serving cells.

30. The method of claim 29, wherein the identifier of the respective serving cell comprises a physical cell identifier, an absolute radio frequency channel number, a sub-band identifier, a component carrier identifier, or a cell identifier.
